(19) United States
(12) Patent Application Publication
(10) Pub. No.: US 2009/0181247 A1
(43) Pub. Date: Jul. 16, 2009

(54) MULTIPLE LAYERED PANELS

(76) Inventors: Jeffery Robert LYNN, Vallejo, CA (US); Steven Eric GOUD, Pacific Grove, CA (US); Peter John ZAAYER, Walnut Creek, CA (US); Joseph Paul REGOLI, Walnut Creek, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/332,212

(22) Filed: Dec. 10, 2008

Related U.S. Application Data
(60) Provisional application No. 61/012,677, filed on Dec. 10, 2007.

(51) Int. Cl. B32B 17/10; B32B 17/06; B05D 5/12

(52) U.S. Cl. 428/339; 428/428; 428/427; 427/58

(57) ABSTRACT

Embodiments described herein provide devices, such as panels, arrays, modules, and/or assemblies, for providing electrical energy, as well as methods for forming the aforementioned devices. In some embodiments, the panels, arrays, and/or assemblies may convert light to electrical energy via the photovoltaic effect. In other embodiments, the panels, arrays, and/or assemblies may convert stored chemical energy to electrical energy via a voltaic process. In other embodiments, the panels, arrays, and/or assemblies may store electrical energy via a capacitance effect. In other embodiments, the panels, arrays, and/or assemblies may collect and/or convert thermal energy and/or magnetic energy to electric energy.

### CROSS-REFERENCE TO RELATED APPLICATIONS

This application claims benefit of U.S. Ser. No. 61/012,677, filed Dec. 10, 2007, which is herein incorporated by reference in its entirety.

### BACKGROUND OF THE INVENTION

1. Field of the Invention

Embodiments of the invention generally relate to panels, and more particularly, to panels containing a plurality of layers and for providing electricity.

2. Description of the Related Art

Currently, renewable energy sources, such as geothermal, wind, or solar, form only a small fraction of the energy used around the world. Several problems associated with these renewable energy sources usually include low peaks of energy or inconsistent amounts of energy, high cost, and geographic limitations. Often, the renewable energy source is situated remotely from the majority of the energy users. Therefore, the electricity formed from the renewable energy source must be transported great distances through power lines, which waste electricity and increases the cost.

Tradition solar cells have been used within or nearby suburban settings, such as on houses and buildings, automobiles, street signs, marine lights, as well as many other devices. However, traditional solar cells are often expensive, provide insufficient amount of needed energy, and inconsistently produce electricity due to unfavorable weather conditions and only during day light hours. Batteries and capacitors may be used to store electricity and offset some of these inefficiencies, but often increase the cost of the electricity. Generally, the cost of electricity from renewable energy sources is too great relative to the cost of electricity derived from traditional hydrocarbon sources.

Therefore, there is a need for devices which provide, produce, and/or store electrical energy at competitive costs.

### SUMMARY OF THE INVENTION

Embodiments described herein provide devices, such as panels, arrays, modules, and/or assemblies, for providing electrical energy, as well as methods for forming the aforementioned devices. In some embodiments, the panels, arrays, and/or assemblies may convert light to electrical energy via the photovoltaic effect. In other embodiments, the panels, arrays, and/or assemblies may convert stored chemical energy to electrical energy via a voltaic process. In other embodiments, the panels, arrays, and/or assemblies may store electrical energy via a capacitance effect. In other embodiments, the panels, arrays, and/or assemblies may collect and/or convert thermal energy and/or magnetic energy to electric energy.

In one embodiment, a panel of layers for providing, producing, or storing electrical energy is provided which includes a base layer containing a base layer binder, crystalline silica, and at least one base layer metal containing cobalt, an intermediate layer containing an intermediate layer binder and crystalline silica, and a top layer containing a top layer binder, crystalline silica, and at least one top layer metal containing aluminum.

In some examples, each of the base layer binder, the intermediate layer binder, and the top layer binder independently contain a vinyl material. The vinyl material may contain at least one material such as vinyl chloride, vinyl isobutyl ether, derivatives thereof, or combinations thereof. For example, the vinyl material may contain a copolymer of vinyl chloride and vinyl isobutyl ether. In other examples, the base layer binder, the intermediate layer binder, and the top layer binder may contain the same binder material. In one example, the base layer may have a thickness within a range from about 70 microns to about 150 microns, the top layer may have a thickness within a range from about 45 microns to about 80 microns, and the intermediate may have a thickness within a range from about 45 microns to about 80 microns.

In some examples, each of the base layer, the intermediate layer, and the top layer may independently contain at least one electrical continuity agent. In many examples, the electrical continuity agent contains iodine. In other examples, the base layer and/or the top layer further contains boron. The base layer may also contain iron, nickel, a combination of iron and nickel, copper, graphite, derivatives thereof, alloys thereof, or combinations thereof. The top layer may also contain cobalt, zinc, tin, a combination of zinc and tin, derivatives thereof, alloys thereof, or combinations thereof.

In another embodiment, a panel of layers for providing, producing, or storing electrical energy is provided which includes a base layer containing a base layer binder, crystalline silica, and at least one base layer metal, an intermediate layer containing an intermediate layer binder and crystalline silica, and a top layer containing a top layer binder, crystalline silica, and at least one top layer metal, a first electrically conductive contact directly coupled to a bottom portion of the top layer, and a second electrically conducing contact directly coupled to a top portion of the base layer.

In another embodiment, a panel of layers for providing, producing, or storing electrical energy is provided which includes a base layer containing iodine, at least one base layer binder, crystalline silica, iron, and copper, an intermediate layer containing iodine, at least one intermediate layer binder, and crystalline silica, a top layer containing iodine, at least one top layer binder, magnesium, zinc, aluminum, and crystalline silica, and a substrate, wherein the base layer is disposed on the substrate, the intermediate layer is disposed on the base layer, and the top layer is disposed on the intermediate layer.

In another embodiment, a panel array containing a plurality of panels connected to provide a current potential, wherein each of the panels further provides a base layer containing iodine, at least one base layer binder, crystalline silica, iron, and copper, an intermediate layer containing iodine, at least one intermediate layer binder, and crystalline silica, a top layer containing iodine, at least one top layer binder, magnesium, zinc, aluminum, and crystalline silica, and a substrate, wherein the base layer is disposed on the substrate, the intermediate layer is disposed on the base layer, and the top layer is disposed on the intermediate layer.

In another embodiment, a method for forming a panel of layers for providing, producing, or storing electrical energy is provided which includes treating a base layer binder with a first electrical continuity agent to prepare a first composition containing the first electrical continuity agent and the base layer binder, treating a base layer metal with a second electrical continuity agent to prepare a second composition containing the second electrical continuity agent and the base layer metal, and combining the first composition and second composition to prepare a base layer composition containing the first electrical continuity agent, the second electrical continuity agent, the base layer metal, and the base layer binder. The method further provides treating a top layer binder with a third electrical continuity agent to prepare a third composition containing the third electrical continuity agent and the top layer binder, treating a top layer metal with a fourth electrical continuity agent to prepare a fourth composition containing the fourth electrical continuity agent and the top layer metal, and combining the third composition and the fourth composition to prepare a top layer composition containing the third electrical continuity agent, fourth electrical continuity agent, the top layer metal, and the top layer binder. The method further provides depositing a base layer from the base layer composition on a substrate, depositing an intermediate layer on the base layer, wherein the intermediate layer contains an intermediate layer binder and a fifth electrical continuity agent, and depositing a top layer from the top layer composition on the intermediate layer.

In some examples, the method provides that each of the first electrical continuity agent, second electrical continuity agent, third electrical continuity agent, fourth electrical continuity agent, and fifth electrical continuity agent independently may contain iodine. In one example, all five electrical continuity agents contain iodine. In other example, the method provides that each of the base layer binder, the intermediate layer binder, and the top layer binder independently contains a vinyl material. The vinyl material may contain at least one material such as vinyl chloride, vinyl isobutyl ether, derivatives thereof, or combinations thereof. For example, the vinyl material may contain a copolymer of vinyl chloride and vinyl isobutyl ether.

In many embodiments, the base layer includes a binder and a filler. In certain embodiments, the filler is selected from, by way of non-limiting example, a metal or multiple metals, monocrystalline silica, or combinations thereof. In some embodiments, the filler includes at least one metal particle and monocrystalline silica. In some embodiments, the base layer additional includes an electrical continuity agent. In a specific embodiment, the base layer includes iodine, at least one binder, monocrystalline silica, iron or ferrite, and copper.

In some embodiments, the intermediate layer includes a binder and a filler. In specific embodiments, the filler includes monocrystalline silica. In certain embodiments, the intermediate layer includes both a filler and an electrical continuity agent. In specific embodiments, the filler contains monocrystalline silica and the electrical continuity agent contains iodine.

In certain embodiments, the top layer includes a binder and a filler. In certain embodiments, the filler is selected from, by way of non-limiting example, a metal or multiple metals, monocrystalline silica, or combinations thereof. In some embodiments, the filler includes at least one metal particle and monocrystalline silica. In some embodiments, the top layer further contains an electrical continuity agent. In a specific embodiment, the top layer includes iodine, aluminum, zinc, magnesium, monocrystalline silica, and at least one binder.

In certain embodiments, the base layer includes iodine, at least one binder, monocrystalline silica, iron or ferrite, and copper, the intermediate layer includes at least one binder and monocrystalline silica, and the top layer includes iodine, aluminum, zinc, magnesium, monocrystalline silica, and at least one binder. In a specific embodiment, the at least one binder of the top, intermediate, and base layers contains a vinyl binder (e.g., a copolymer of vinyl chloride and vinyl isobutyl ether, such as MP-15).

Fillers include, by way of non-limiting example, monocrystalline silica, and metals (e.g., metal particles, including polarizable metal particles). In more specific embodiments, fillers include, by way of non-limiting embodiment, strontium ferrite powder, magnesium, zinc, beryllium, aluminum, aluminum alloys, cadmium, mild steel, cast iron, low alloy steel, austenitic nickel cast iron, aluminum bronze, naval brass, yellow brass, red brass, tin, copper, Pb—Sn solder, admiralty bras, aluminum brass, manganese bronze, silicone bronze, tin bronzes (G & M), stainless steel (e.g., types 302, 304, 316, 317, 321, 347, 410, 416, 430), nickel silver, copper nickel (including 90-10, 80-20, 70-30), lead, nickel-aluminum bronze, nickel-chromium alloys (e.g., 600), silver braze alloys, nickel 200, silver, nickel-copper alloys (e.g., 400, K-500), alloy 20 stainless steels cast and wrought, nickel-iron chromium alloys (e.g., 825), Ni—Cr—Mo—Cu—Si alloy B, titanium, Ni—Cr—Mo alloy C, platinum, graphite, iron, nickel manganese, chromium, ferrite, bismuth, lithium, boron, mono-silicon, amorphous silicon, phosphorus, scandium, vanadium, molybdenum, graphite, cobalt (e.g., flake and/or powder), gallium, yttrium, zirconium, alloys thereof, derivatives thereof, or combinations thereof. In some embodiments, the top and base layers contain a different combination of fillers. In some embodiments, the fillers described herein are particles that are dispersed in the layers or paints described herein. In some specific embodiments, the top layer fillers are selected from aluminum, zinc, magnesium, monocrystalline silica, or combinations thereof. In certain specific embodiments, the base layer fillers are selected from copper, monocrystalline silica, iron or ferrite, or combinations thereof.

In some embodiments, the binders of each of the top, intermediate, and base layers are different. In other embodiments, the binders of two of the top, intermediate, and base layers are the same and the other is different. In still other embodiments, the binders of the top, intermediate, and base layers are the same. Typical binders include, by way of non-limiting example, epoxy resins, vinyls, acrylic resins, alkyds, polysiloxanes, urethanes, resins, hydrocarbon resins, enamel resins, polyamine resins, polyamide resins, synthetic resins, modified enamel resins, polyurethanes, polyesters, polymer resins, copolymer resins, ethyl silicate, potassium silicate, silicone, siloxane, polyampholyte, an extrudable film base, a water base, derivatives thereof, or combinations thereof. In specific embodiments, the binder is a vinyl binder, such as a vinyl chloride, vinyl isobutyl ether, a copolymer of vinyl chloride and vinyl isobutyl ether, derivatives thereof, or combinations thereof. In various embodiments, the vinyl binder may contain polymers, copolymers, or oligomers, and, by way of non-limiting example, contain MP-15, MP-25, MP-35, MP-45, or MP-60. In one example, the vinyl binder contains a copolymer of vinyl chloride and vinyl isobutyl ether, such as the commercially available MP-15 copolymer.

In some embodiments, the electrical continuity agent is a doping agent or dopant. In specific embodiments, the electrical continuity agent is iodine. Suitable sources of iodine used herein include, by way of non-limiting example, crystalline iodine and bleached iodine. In certain embodiments, the electrical continuity agent is an agent that facilitates the reduction of dielectric resistance within and/or between the layers of the panels described herein.

In some specific embodiments, a panel is provided and contains a base layer, an intermediate layer, and a top layer. In some embodiments, the base layer contains a base layer metal and a base layer binder, the intermediate layer contains an intermediate layer metal and an intermediate layer binder, and the top layer contains a top layer metal and a top layer binder. In certain embodiments, the base layer metal, base layer binder, intermediate layer metal, intermediate layer binder, top layer metal, and top layer binder are all treated with an electrical continuity agent. In certain embodiments, each of the base layer metal, base layer binder, intermediate layer metal, intermediate layer binder, top layer metal, and top layer binder are individually and independently treated with an electrical continuity agent (e.g., iodine) prior to being combined in their respective layers.

In some embodiments, the base layer is in direct physical contact with a substrate. In other embodiments, the base layer is in direct physical contact with a primer layer. In certain embodiments, the primer layer is utilized in order to improve uniformity of the surface of the substrate. It is to be understood that as used herein, a base layer deposited on a substrate may be directly deposited onto the substrate or onto a primer layer disposed on the substrate.

In certain embodiments, the panels further contain a protective layer that is applied to the top layer. In some embodiments, the protective layer protects the underlying paint layer structure from weathering and damage, including, e.g., scratching. In some embodiments, the protective layer includes a binder. In certain embodiments, the protective layer contains the same composition as the top layer, with the exception that it does not contain any fillers.

In some embodiments, one or more of the layers described herein is polarized. The layers can be polarized by any method, including those described by methods herein. In certain embodiments, the layers are polarized by exposing the layer to an electromagnetic field. In more specific embodiments, a layer paint is applied to either a substrate or another layer and the layer is polarized with an electromagnetic field prior to curing and/or drying of the layer.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-1C depict various views of a panel as described in some embodiments herein;

FIGS. 2A-2C depict various views of a solar panel as described in other embodiments herein;

FIG. 3 illustrates various embodiments of the directions in which the layers disclosed herein may be polarized; and

FIG. 4 illustrates a panel module, panel array, and a panel assembly of other embodiments described herein.

### DETAILED DESCRIPTION

While embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing embodiments of the invention. It is intended that the following claims define the scope of the invention and that methods and structures within the scope of these claims and their equivalents be covered thereby.

Embodiments described herein provide panels, arrays, and/or assemblies for providing electrical energy. In some embodiments, the panels, arrays, and/or assemblies may convert light to electrical energy via the photovoltaic effect. In other embodiments, the panels, arrays, and/or assemblies may convert stored chemical energy to electrical energy via a voltaic process. In other embodiments, the panels, arrays, and/or assemblies may store electrical energy via a capacitance effect. In other embodiments, the panels, arrays, and/or assemblies may collect and/or convert thermal energy and/or magnetic energy to electric energy.

Accordingly, in certain specific embodiments, a panel contains a base layer, an intermediate layer, and a top layer. In some embodiments, the base layer and the top layer may be polarized layers. In some embodiments, the base layer contains a base layer metal and a base layer binder, the intermediate layer contains an intermediate layer binder, and the top layer contains a top layer metal and a top layer binder. In certain embodiments, the base layer is polarized in a first direction and the polarized top layer is polarized in a second direction. In these embodiments, the polarized base layer is deposited on a substrate, the intermediate layer is deposited on the polarized base layer, and the polarized top layer is deposited on the intermediate layer. In some embodiments, the first and second directions are the same. In other embodiments, the first and second directions are different. In some embodiments, the intermediate layer is polarized in a third direction. In certain embodiments, the first, second, and third directions are the same. In other embodiments, two or more of the first, second, and third directions are the same. In yet other embodiments, none of the first, second, and third directions are the same. In some embodiments, the base layer contains a second base layer metal and/or a second base layer binder. In certain embodiments, the top layer contains a second top layer metal and/or a second top layer binder. In some embodiments, the intermediate layer contains a second intermediate layer binder. In certain embodiments, the base layer further contains at least one electrical continuity agent. In some embodiments, the top layer further contains at least one electrical continuity agent. In some embodiments, the intermediate layer further contains at least one electrical continuity agent. In specific embodiments, the top and base layers both contain at least one electrical continuity agent. In more specific embodiments, the top, intermediate, and base layers all contain at least one electrical continuity agent. In various embodiments, the electrical continuity agents for each of the layers is the same or different.

Furthermore, in other embodiments, the panel contains a polarized base layer, a polarized intermediate layer, and a polarized top layer. In some embodiments, the polarized base layer contains iodine, at least one base layer binder (e.g., a copolymer of vinyl chloride and vinyl isobutyl ether, such as MP-15), monocrystalline silica, iron or ferrite, and copper. In certain embodiments, the intermediate layer contains iodine, at least one intermediate layer binder (e.g., a copolymer of vinyl chloride and vinyl isobutyl ether, such as MP-15), and monocrystalline silica. In some embodiments, the polarized top layer contains iodine, at least one top layer binder (e.g., a copolymer of vinyl chloride and vinyl isobutyl ether, such as MP-15), magnesium, zinc, aluminum, or monocrystalline silica. In some examples, the polarized base layer is polarized in a first direction, the polarized top layer is polarized in a second direction and the intermediate layer is polarized in a third direction. Furthermore, the polarized base layer is deposited on a substrate, the intermediate layer is deposited on the polarized base layer, and the polarized top layer is deposited on the intermediate layer. In certain embodiments, the at least one base layer binder, the at least one intermediate layer binder and the at least one top layer binder are the same. In specific embodiments, the at least one intermediate layer binder and the at least one top layer binder contain a vinyl material. In more specific embodiments, the at least one intermediate layer binder and the at least one top layer binder comprise a copolymer of vinyl chloride and vinyl isobutyl ether, such as MP-15.

In some embodiments, the panel contains one or more electrically conductive contacts. In certain embodiments, the electrically conductive contact is a strip of electrically conductive material (e.g., a conductive metal) that is in contact with one or more layer of the panel. In one example, contains at least two electrical contacts.

In one embodiment, the panel includes a first and second electrically conductive contact that is in direct physical contact with the base layer and either the substrate, a primer layer, or an insulating layer. In some embodiments, the electrically conductive contacts cover only a fraction of the bottom portion of the base layer. In certain embodiments, the first and second electrically conductive contacts are on opposite ends/sides of the base layer and extend down the length of the end/side. In some embodiments, the electrically conductive contacts extend down the entire length of the end/side. In other embodiments, the electrically conductive contacts extend down a portion of the length of the end/side, stopping short of either corner.

In other embodiments, the panel includes a first and second electrically conductive contact that is in direct physical contact with the top layer and the intermediate layer. In some embodiments, the electrically conductive contacts cover only a fraction of the bottom portion of the top layer and/or of the top portion of the intermediate layer. In certain embodiments, the first and second electrically conductive contacts are on opposite sides of the top and intermediate layers and extend down the length of the side/end. In some embodiments, the electrically conductive contacts extend along the entire length of the side/end. In other embodiments, the electrically conductive contacts extend along a portion of the length of the side/end, stopping short of either corner. In certain embodiments, the electrically conductive contacts extend inward from the edge of the side/end of the top and intermediate layers far enough to allow the electrical current produced by the panel to pass through the electrically conductive contact. In some embodiments, the extent to which the electrically conductive contacts extend inward from the edge of the side/end is determined by minimizing the resistance encountered by the electrical current generated by the panel flows to the electrically conductive contacts.

In still other embodiments, the panel includes a first and second electrical conductive contact that is in direct physical contact with the base layer and either the substrate, a primer layer, or an insulating layer, and a third and fourth electrical conductive contact that is in direct physical contact with the top layer and the intermediate layer.

In those embodiments wherein the panel includes an insulating layer separating the electrically conductive contact from either a primer layer or the substrate, the insulating layer separates the electrically conductive contact from either the substrate or primer layer in order to prevent electrical current from flowing into either the primer layer or the substrate. In various embodiments, the insulating layer covers, by way of non-limiting example, the bottom portion of the conductive contact, the bottom and one or more side portions of the conductive contact, or the entire bottom portion of the panel, including the electrically conductive contact and the portion of the base layer that is not in direct contact with the electrically conductive contact (e.g., an insulating primer layer).

In other embodiments, the panel contains a base layer, an intermediate layer, a top layer, a first electrically conductive contact, a second electrically conducing contact, a third electrically conductive contact, and a fourth electrically conductive contact. In certain embodiments, the base layer contains a base layer metal and a base layer binder, the intermediate layer contains an intermediate layer metal and an intermediate layer binder, and the top layer contains a top layer metal and a top layer binder. In some embodiments, the base layer as a bottom portion and a top portion, the intermediate layer has a bottom portion and a top portion, and the top layer has a bottom portion and a top portion. In some embodiments, the first electrically conductive contact is in direct physical contact with the top portion of the intermediate layer and the bottom portion of the top layer, the second electrically conductive contact is in direct physical contact with the top portion of the intermediate layer and the bottom portion of the top layer, the third electrically conductive contact is in direct physical contact with the top portion of the base layer, and the fourth electrically conductive contact is in direct physical contact with the top portion of the base layer. In certain embodiments, when taken together, the first and second electrically conductive contacts cover a fraction of the bottom portion of the top layer.

Furthermore, in some embodiments, the first and second electrically conductive contacts cover a fraction of the top portion of the intermediate layer. In some embodiments, the third and fourth electrically conductive contacts cover a fraction of the bottom portion of the base layer. In some embodiments, the first and second electrically conductive contacts cover less than 50% of the bottom portion of the top layer. In specific embodiments, the first and second electrically conductive contacts cover less than about 35%, 25%, 20%, 15%, 10%, 5%, 3%, 2%, or 1% of the bottom portion of the top layer. Similarly, in various embodiments, the first and second electrically conductive contacts cover less than about 50%, 35%, 25%, 20%, 15%, 10%, 5%, 3%, 2%, or 1% of the top portion of the intermediate layer. In some embodiments, the third and fourth electrically conductive contacts cover less than about 50%, 35%, 25%, 20%, 15%, 10%, 5%, 3%, 2%, or 1% of the top portion of the base layer.

The panel, as described herein, may be in any shape. In some embodiments, the panel is substantially square. In other embodiments, the panel is substantially rectangular. In still other embodiments, the panel is substantially trapezoidal, oval, or circular. In yet other embodiments, the panel has a substantially parallelogram-type shape. In some embodiments, the panel is shaped in a manner to fit the surface or substrate upon which it is placed. For example, in some embodiments of the invention, the panels described herein may be deposited on surfaces of automobiles, buildings, sidewalks, roads, street signs, or other available surfaces.

For convenience, the shapes described herein are described as having ends, sides, and corners, but the scope of the invention is not limited to shapes having portions that would conventionally be described as an end, a side or a corner. For convenience, the shapes described herein have been described as possessing two end portions and two side portions. Since the panel is described herein with a definite shape, the two end portions are simply defined as two portions that are opposite each other. Likewise, the two side portions are simply defined as two portions that are opposite each other and adjacent to the end portions. Similarly, a corner as described herein is simply a junction between an end portion and a side portion. In some embodiments, the junction is continuous and unpronounced (e.g., in embodiments wherein the panel is circular in shape), whereas in other embodiments, the junction is pronounced (e.g., in embodiments wherein the panel has a square shape).

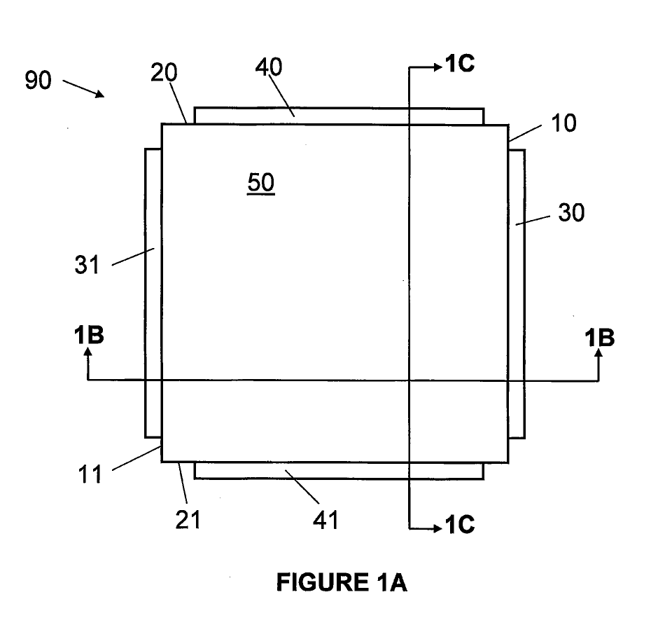

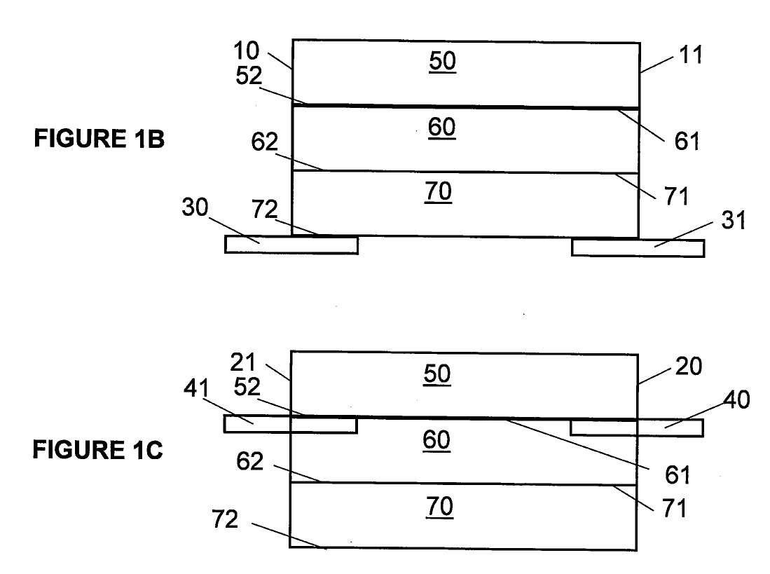

FIGS. 1A-1C illustrate various views of panel 90 as described in some embodiments herein. FIG. 1A illustrates a plan view of panel 90 and FIGS. 1B-1C illustrate a cross sectional view of various layers of panel 90. FIG. 1A illustrates an exemplary embodiment of panel 90, which has a substantially square shape with two sides 10, 11 opposite one another. The two sides 10, 11 are adjacent to the two ends 20, 21, which are opposite of each other. Conductive electrical contacts 30, 31 extend along a portion of the length of each side 10, 11. Similarly, conductive electrical contacts 40, 41 extend along a portion of the length of each end 20, 21. As the figure is viewed from the top, the top layer 50 is shown.

FIG. 1B illustrates a sectional view of panel 90 along the 1B-1B plane. The bottom portion 52 of the top layer 50 is in direct physical contact with the top portion 61 of the intermediate layer 60. The bottom portion 62 of the intermediate layer 60 is in direct physical contact with the top portion 71 of the base layer 70. The conductive electrical contacts 30, 31 are shown to extend partially inward from the sides 10, 11 and along the bottom portion 72 of the base layer 70. Furthermore, the conductive electrical contacts 30, 31 are shown to extend outward from the sides 10, 11.

FIG. 1C illustrates a sectional view of panel 90 along the 1C-1C plane. The bottom portion 52 of the top layer 50 is in direct physical contact with the top portion 61 of the intermediate layer 60. The conductive electrical contacts 40, 41 are shown to extend partially inward from the ends 20, 21 and along the bottom portion 52 of the top layer 50 and along the top portion 61 of the intermediate layer 60. Furthermore, the conductive electrical contacts 40, 41 are shown to extend outward from the ends 20, 21. The bottom portion 62 of the intermediate layer 60 is in direct physical contact with the top portion 71 of the base layer 70.

It is also to be understood that in various embodiments of the invention, panel 90 may be deposited on any suitable substrate. Accordingly, in some embodiments, panel 90 is substantially flat, curved or bent. For example, in some embodiments, panel 90 is deposited on the curved roof of an automobile. Suitable substrates include, by way of non-limiting example, steel, concrete, aluminum, wood, cast iron, sheet metal, plastic, tin, fiberglass, or acrylic, such as PLEXIGLAS® acrylic sheets. Furthermore, suitable substrates also include existing coatings, such as paint or primer layers. For example, in some embodiments, panel 90 may be deposited on a painted building or automobile.

The layers described herein may be used in any thickness suitable for storing, producing, or releasing electricity from the panel 90. In certain embodiments, the top layer, intermediate layer, and optional protective layers are thin enough that they are at least partially transparent. In some embodiments, the top layer, intermediate layer, and optional protective layers are substantially transparent. In specific embodiments, the top layer has a thickness of between about 45 microns and about 80 microns. In some embodiments, the intermediate layer has a thickness of between about 45 microns and about 80 microns. In some embodiments, the thickness of the base layer is not limited by a need for transparency. Thus, in certain embodiments, the base layer is any thickness. In some specific embodiments, however, the base layer has a thickness of between about 70 microns and about 150 microns.

It is also to be understood that in various embodiments of the invention, panel 90 may contain additional layers or less layers. For example, in addition to a base layer, an intermediate layer, and a top layer, certain embodiments of the invention provide that panel 90 may contain a second intermediate layer in direct physical contact with the top layer and a second top layer that is in direct physical contact with the second intermediate layer. The composition and the thickness of the second intermediate layer and the second top layer are as described herein for the intermediate layer and top layer. The second intermediate layer and the second top layer may have the same or different composition and/or thickness as the intermediate layer and top layer of panel 90 in which they are manufactured. Furthermore, as disclosed for between the top layer and intermediate layer, one or more electrically conductive contacts may be positioned between the second intermediate layer and the second top layer.

In some embodiments, panel 90 contains any one or more of the layers described herein. Accordingly, in some embodiments, panel 90 may have one or more of the layers described herein which are utilized in any position within panel 90, whether or not it fits within the designation of “base,” “intermediate,” or “top.” Thus, in some embodiments, the panel contains a layer, wherein the layer contains the components as described herein for a base layer. In some embodiments, the panel contains a layer, wherein the layer contains the components as described herein for a top layer. In certain embodiments, the panel contains a layer, wherein the layer contains the components as described herein for an intermediate layer.

In more specific embodiments, the panel contains a first layer and a second layer, wherein the first layer contains the components as described herein for a base layer and the second layer contains the components as described herein for a top layer. In various embodiments, the first and second layers are deposited in any order (e.g., in some embodiments, the first layer is a base layer and the second layer is a top layer). In some embodiments, the first and second layers are in direct physical contact (e.g., the second layer is deposited directly on top of the first layer).

In even more specific embodiments, the panel contains a first layer, a second layer and a third layer, wherein the first layer contains the components as described herein for a base layer, the second layer contains the components as described herein for a top layer and the third layer contains the components as described herein for an intermediate layer. In various embodiments, the first, second and third layers are deposited in any order.

In other embodiments, a method for making the panel is provided herein. In some embodiment, the panel may be prepared, deposited, or formed by using painting techniques. Suitable painting techniques include, by way of non-limiting example, application by brush, roller, conventional spray equipment, airless spray equipment, or electrostatic spray.

In certain embodiments, a base layer of the panel may be prepared by depositing, using suitable painting techniques, a base layer paint on a substrate (including, e.g., a substrate coated with a primer layer). In some embodiments, the base layer paint is deposited on a substrate and one or more electrically conductive contacts. In some embodiments, the base layer paint is then dried to remove some, substantially all of or all of the paint vehicle and achieve a base layer. In certain embodiments, the base layer paint includes a binder, a filler and a paint vehicle. In certain embodiments, the filler is selected from, by way of non-limiting example, a metal, monocrystalline silica, or combinations thereof. In some embodiments, the filler includes at least one metal particle and monocrystalline silica. In some embodiments, the base layer paint includes an electrical continuity agent. In a specific embodiment, the base layer includes iodine, at least one binder, at least one paint vehicle, monocrystalline silica, iron or ferrite, and copper. In a more specific embodiment, the at least one binder comprises a copolymer of vinyl chloride and vinyl isobutyl ether, such as MP-15.

Likewise, in certain embodiments, an intermediate layer of the panel may be prepared by depositing, using suitable painting techniques, an intermediate layer paint on a base layer. In some embodiments, the intermediate layer paint is then dried to remove some, substantially all of or all of the paint vehicle and achieve an intermediate layer. In some embodiments, the intermediate layer paint includes a binder, a filler and a paint vehicle. In specific embodiments, the filler includes monocrystalline silica. In some embodiments, the intermediate layer paint further contains an electrical continuity agent. In specific embodiments, the filler is monocrystalline silica, the electrical continuity agent is iodine and the binder comprises a copolymer of vinyl chloride and vinyl isobutyl ether, such as MP-15.

In certain embodiments, the top layer of the panel may be prepared by depositing, using suitable painting techniques, a top layer paint on the intermediate layer. In some embodiments, the top layer is prepared by depositing the top layer paint on an intermediate layer and one or more electrically conductive contacts (e.g., wherein the electrically conductive contacts cover at least a portion of the intermediate layer). In some embodiments, the top layer paint is then dried to remove some, substantially all of or all of the paint vehicle and form the top layer. In certain embodiments, the top layer paint includes a binder, a filler and a paint vehicle. In certain embodiments, the filler is selected from, by way of non-limiting example, a metal, monocrystalline silica, or combinations thereof. In some embodiments, the filler includes at least one metal particle and monocrystalline silica. In some embodiments, the top layer paint further contains an electrical continuity agent. In a specific embodiment, the top layer paint includes iodine, at least one paint vehicle, aluminum, zinc, magnesium, monocrystalline silica, and at least one binder. In more specific embodiments, the at least one binder contains a copolymer of vinyl chloride and vinyl isobutyl ether, such as MP-15.

In certain embodiments, the base layer paint includes at least one paint vehicle, iodine, at least one binder, monocrystalline silica, iron or ferrite, and copper, the intermediate layer includes at least one binder and monocrystalline silica, and the top layer paint includes at least one paint vehicle, iodine, aluminum, zinc, magnesium, monocrystalline silica, and at least one binder. In a specific embodiment, the at least one binder of the top, intermediate and base layer paints is a vinyl binder (e.g., binder comprises a copolymer of vinyl chloride and vinyl isobutyl ether, such as MP-15).

It is to be understood that the step of drying any of the paints described herein includes partially drying, at least partially drying and completely drying the paint. In other words, the drying step involves removing some, substantially all of or all of the paint vehicle in the paint. In some embodiments, the paints are dried at any temperature suitable. The temperature and length of time necessary to dry the paint depends on the thickness of the paint layer and the nature of the paint vehicle used. In certain embodiments, the drying temperature is between about 0° C. and about 80° C. In specific embodiments, the drying temperature is between about 4° C. and about 45° C. In more specific embodiments, the drying temperature is about 20° C. to about 25° C. In certain embodiments of the invention, the time required for drying the paints will depend on the temperature and humidity of the environment at which the paint is dried while forming the layers of the panel. In some embodiments, the paints are dried for an amount of time sufficient to achieve the level of dryness or to remove the amount of paint vehicle desired (e.g., partial, at least partial, or complete drying). In certain embodiments, the paint is dried for between about 1 minute and about 24 hours. In specific embodiments, the paint is dried for between about 30 minutes and about 8 hours. In specific embodiments, the paint is dried for between about 1 hour and about 6 hours. In more specific embodiments, the paint is dried for about 4 hours.

Accordingly, base layer, intermediate layer, and top layer paints include the components (e.g., fillers or binders) described hereinabove for the panel layer indicated as well as at least one flowable paint vehicle (e.g., a solvent).

In various embodiments, the flowable paint vehicle or solvent of the base layer, intermediate layer and top layer paints are the same or different from one another. In certain embodiments, additives to aid in flow modification and/or impart other properties on the paint composition are included in the paint. In some embodiments, the paint is initially in flowable form. In these embodiments, the paint is applied in the flowable form and thereafter cures and/or dries to a solid form with the filler agents in a solid binder. The solid binder serves as a matrix in which the fillers are embedded and dispersed to form the various layers of the panel.

Paint vehicles or solvents include, by way of non-limiting example, water, acetone, naphtha, terpene alcohol, alpha-terpineol, methyl ethyl ketone (MEK), xylene, methyl isobutyl ketone (MIBK), glycol ethers, hydrocarbons, halogenated hydrocarbons, oxygenated hydrocarbons, or combinations thereof. Examples of terpene alcohol and acetone mixtures, such as TARKSOL® 97 solvent, TARKSOL® SC Plus solvent, TARKSONE® solvent, available from Tarksol International, L.L.C.

As described herein, in certain embodiments, the paints may contain a paint vehicle, a binder, and a filler. In some embodiments, the paints may be prepared by treating each individual component with an electrical continuity agent. In certain embodiments, each binder component and each filler component are treated individually with an electrical continuity agent. In some embodiments, each binder component and each filler component are treated individually with an electrical continuity agent in a solvent. In some embodiments, the compositions containing the solvent and the individually treated components are combined to form the paint. In other embodiments, the solvent is removed, the individually treated components are combined and a paint vehicle is added to form the paint. In still other embodiments, the solvent is removed from at least one of the individually treated components prior to combining the treated components to form the paint. In such embodiments, an additional paint vehicle may or may not be added to the paint.

In some embodiments, one or more of the layers described herein is polarized. In various embodiments, the layers are polarized by any method effective therefore. In certain embodiments, the layers are polarized by exposing the layer to an electromagnetic field. In one embodiment, a layer is polarized by connecting one end/side of a layer to the cathode of a battery and connecting the opposite end/side to the anode. In certain embodiments, after a paint is applied to either a substrate or another layer, but prior to complete drying and/or curing of the paint, the layer is polarized with an electromagnetic field. In some embodiments, the base layer, intermediate layer and top layer are all polarized. In certain embodiments, each of the base layer is polarized in a first direct, the intermediate layer is polarized in a second direction and the top layer is polarized in a third direction. In some embodiments, one or more of the first, second and third directions are the same. In other embodiments, none of the first, second and third directions are the same. In some embodiments, the top layer and base layer are polarized, but the intermediate layer is not polarized. In such embodiments, the panels may contain the top layer and the base layer polarized in either the same direction or in different directions.

In specific embodiments, the method for preparing a panel includes the steps of (i) treating a base layer binder with a first electrical continuity agent to prepare a first composition comprising the first electrical continuity agent and the base layer binder; (ii) treating a base layer metal with a second electrical continuity agent to prepare a second composition comprising the second electrical continuity agent and the base layer metal; (iii) combining the first composition and second composition to prepare a base layer paint comprising the first electrical continuity agent, the second electrical continuity agent, the base layer metal and the base layer binder; (iv) treating a top layer binder with a third electrical continuity agent to prepare a third composition comprising the third electrical continuity agent and the top layer binder; (v) treating a top layer metal with a fourth electrical continuity agent to prepare a fourth composition comprising the fourth electrical continuity agent and the top layer metal; (vi) combining the third composition and the fourth composition to prepare a top layer paint comprising the third electrical continuity agent, fourth electrical continuity agent, the top layer metal and the top layer binder; (vii) depositing the base layer paint on a substrate; (viii) depositing an intermediate layer paint on the base layer paint; and (ix) depositing the top layer paint on the intermediate layer paint, wherein the intermediate layer paint contains an intermediate layer binder and a fifth electrical continuity agent.

In some embodiments, the base layer binder is treated with the first electrical continuity agent in a first solvent and the base layer metal is treated with a second electrical continuity agent in a second solvent. In certain embodiments, the first composition contains the first solvent and the second composition contains the second solvent (and as a result, the base layer paint contains the first and second solvents). In other embodiments, one or both of the first and second solvents are removed and, as a result, the first and/or second compositions do not contain the first or second solvents, respectively. In such embodiments, the base layer paint contains one or none of the first or second solvents. In some embodiments wherein the first and/or second solvents are present in the base layer paint, the solvents present are the base layer paint vehicle. In some embodiments, a paint vehicle or solvent may be included in the base layer paint, whether or not either of the first or second solvents is present therein.

Similarly, in certain embodiments, the top layer binder is treated with the third electrical continuity agent in a third solvent and the top layer metal is treated with a fourth electrical continuity agent in a fourth solvent. In certain embodiments, the third composition contains the third solvent and the fourth composition contains the fourth solvent (and as a result, the top layer paint contains the third and fourth solvents). In other embodiments, one or both of the third and fourth solvents are removed and, as a result, the third and/or fourth compositions do not contain the third or fourth solvents, respectively. In such embodiments, the top layer paint contains one or none of the third or fourth solvents. In some embodiments wherein the third and/or fourth solvents are present in the top layer paint, the solvents present are the top layer paint vehicle. In some embodiments, a paint vehicle is added to the top layer paint, whether or not either of the third or fourth solvents is present therein.

Likewise, in some embodiments, the intermediate layer binder is treated with the fifth electrical continuity agent in a fifth solvent. In some embodiments, the intermediate layer paint contains the fifth solvent as a paint vehicle or in addition to a paint vehicle. In other embodiments, the fifth solvent is removed prior to preparation of the intermediate layer paint.

In some embodiments, following the step of depositing the base layer paint on a substrate and prior to depositing of the intermediate layer paint on the deposited base layer paint, the deposited base layer paint is dried. Similarly, in some embodiments, following the step of depositing an intermediate layer paint on the deposited base layer paint and prior to the step of depositing the top layer paint on the deposited intermediate layer paint, the deposited intermediate layer paint is dried. As discussed herein, the step of drying includes partially drying, at least partially drying and completely drying the paint.

In certain embodiments, one or more of the layers is polarized. In some embodiments, a layer is polarized by exposing the deposited paint layer to an electromagnetic field. In a specific embodiment, the base layer is polarized after deposition of the base layer paint, but prior to drying of the base layer paint. In some embodiments, the intermediate layer is polarized after deposition of the intermediate layer paint, but prior to drying of the intermediate layer paint. In certain embodiments, the top layer is polarized after deposition of the top layer paint, but prior to drying of the top layer paint. In some embodiments, the top layer is polarized. In specific embodiments, the top and base layers are polarized. In more specific embodiments, the top, intermediate, and base layers are polarized.

Furthermore, as discussed herein, because the base layer need not be transparent, the deposited base layer paint may have a variety of thicknesses. In some embodiments, the deposited base layer paint may have a thickness within a range from about 2 mils DFT (dry film thickness) to about 10 mils DFT. In some embodiments, the deposited base layer paint may have a thickness within a range from about 4 mils DFT to about 6 mils DFT. In specific embodiments, the deposited base layer paint may have a thickness of about 5 mils DFT. In some embodiments, the top and intermediate layers have a thickness that is thin enough to be at least partially transparent. In certain embodiments, deposited the intermediate layer may have a thickness within a range from about 1 mils DFT to about 5 mils DFT. In specific embodiments, the deposited intermediate layer may have a thickness within a range from about 2 mils DFT to bout 3 mils DFT. In some embodiments, the deposited top layer may have a thickness within a range from about 1 mils DFT to about 5 mils DFT. In specific embodiments, the deposited top layer may have a thickness within a range from about 2 mils DFT and bout 3 mils DFT.

In some embodiments, the first, second, third, fourth, and fifth electrical continuity agents are the same. In other embodiments, one or more of the first, second, third, fourth, and fifth electrical continuity agents are the same. In still other embodiments, the first, second, third, fourth, and fifth are different. In certain embodiments, the first, second, third, fourth, and fifth electrical continuity agents are iodine. In some embodiments, the first, second, third, fourth, and fifth solvents are the same. In other embodiments, one or more of the first, second, third, fourth, and fifth solvents are the same. In still another embodiment, none of the first, second, third, fourth, and fifth solvents are the same.

In some embodiments, the panels described herein convert solar energy into electrical energy via the photovoltaic process. In certain embodiments, the solar energy is visible light, non-visible light, or a combination thereof. Furthermore, in some embodiments, the “panels” described herein are panels suitable for collecting, storing, forming, various forms of energy (solar or otherwise) and converting such energy into electrical energy. The process of converting these various forms of energy to electrical energy may or may not involve the photovoltaic process. In some embodiments, the panels, arrays, and/or assemblies may convert stored chemical energy to electrical energy via a voltaic process. In other embodiments, the panels, arrays, and/or assemblies may store electrical energy via a capacitance effect. In other embodiments, the panels, arrays, and/or assemblies may collect and/or convert thermal energy and/or magnetic energy to electric energy.

In some embodiments, a panel assemblage includes one or more panels, modules, and/or arrays as described herein. In certain embodiments, the panel arrays contain a plurality of any of the panels described herein. In certain embodiments, the panels are connected within the arrays to provide a direct current potential. In various embodiments of the invention, the panels of the arrays are connected in parallel, in series, or in a combination thereof.

In certain embodiments, the panel, panel module, panel array, or panel assemblage produces direct current. In some embodiments, a panel assemblage contains a power inverter that converts direct current to alternating current. In some embodiments, a panel module, a panel array, or a panel assemblage contains a direct current combiner that combines direct current of a plurality of panels or panel modules that are connected in parallel.

In some embodiments, the panels present in the panel module are connected to one another by an electrically conductive material. In specific embodiments, an electrically conductive contact of a first panel is connected by an electrically conductive material to an electrically conductive contact of a second panel. In more specific embodiments, an electrically conductive contact of a first panel is in direct physical contact with an electrically conductive contact of a second panel. In some embodiments, wherein a panel contains a first, second, third and fourth electrically conductive contact (e.g., in some embodiments wherein the first and second are between the top and intermediate layers and the third and fourth are in direct physical contact with the bottom portion of the base layer), the first electrically conductive contact is connected to the third electrically conductive contact, the second electrically conductive contact is connected to an electronically conductive contact of a second panel, and the fourth electrically conductive contact is connected to an electronically conductive contact of a third panel. In other embodiments, wherein a first panel contains a first, second, third and fourth electrically conductive contact (e.g., in some embodiments wherein the first and second are between the top and intermediate layers and the third and fourth are in direct physical contact with the bottom portion of the base layer), the first electrically conductive contact is connected to a second panel (e.g., to the second electrically conductive contact of the second panel), the second electrically conductive contact is connected to an electronically conductive contact of a third panel (e.g., to the first electrically conductive contact of the third panel), the third electronically conductive contact is connected to a fourth panel (e.g., to the fourth electrically conductive contact of the fourth panel) and the fourth electrically conductive contact is connected to an electronically conductive contact of a fifth panel (e.g., to the third electrically conductive contact of the fifth panel). In such embodiments, the top layers of the first, second and third panels are connected in series and the base layers of the first, fourth and fifth panels are connected in series. All manners of connecting multiple panels of the present invention are envisioned herein.

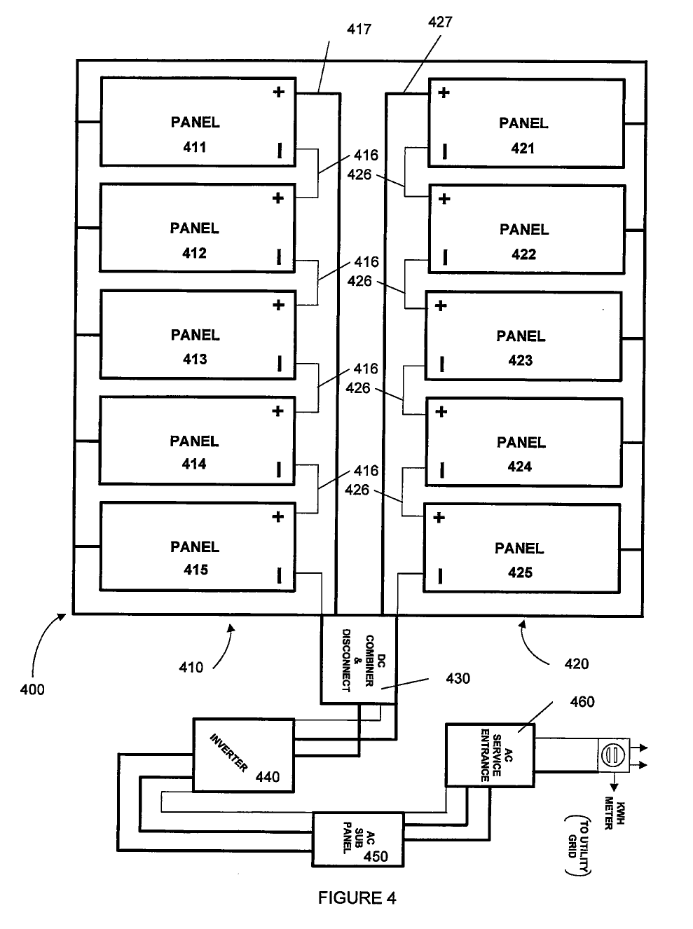

In an alternative embodiment, FIG. 4 illustrates an exemplary embodiment of an assemblage comprising a panel array. Panel array 400 is made up of two panel modules 410, 420. The panel module 410 is made up of a set of panels 411, 412, 413, 414, 415, which are connected in series by electrically conductive material 416. Likewise, panel module 420 is made up of a set of panels 421, 422, 423, 424, 425, which are connected in series by electrically conductive material 426. Panel module 410 and panel module 420 are connected in parallel by electrically conductive material 417, 427 at the direct current combiner and disconnect 430. The direct current (DC) produced by the panel array proceeds from the direct current combiner and disconnect 430 to the inverter 440 where the current is converted to alternating current (AC). The alternating current proceeds to the alternating current subpanel 450 and on to the alternating current service entrance 460 before proceeding to a utility grid.

It is to be understood that FIG. 4 is for illustrative purposes only. For example, in some embodiments, a panel, a panel module, a panel array, or a panel assemblage provides electrical current for a building without first feeding a utility grid. In other embodiments, a panel, a panel module, a panel array, or a panel assemblage provides electrical current for an automobile. In still other embodiments, a panel, a panel module, a panel array, or a panel assemblage provides electrical current for a satellite. Furthermore, in some embodiments, the direct current produced by the panel, panel module, panel array, or panel assemblage is utilized without first converting it to alternating current. In certain embodiments, a panel assemblage contains a single panel.

In some embodiments, the panel array contains a plurality of electrically connected modules. In some embodiments, at least one or some of the panel modules include electrically connected panels that are described herein. Accordingly, in certain embodiments, the panel modules include a plurality of panels formed of multiple layers containing one or more filler and one or more binder within each of the layers. In some embodiments, the fillers are selected from metals (e.g., polarizable metal particles) and monocrystalline silica. In certain embodiments, the combination of fillers utilized in each of the layers is different. In certain embodiments, each layer further contains a common electrical continuity agent for facilitating reduction of dielectric resistance within and between the multiple layers.

### Solar Panels

In an alternative embodiment of the invention, solar cells or panels, may be formed from multiple stacked layers formed of materials that facilitate the conversion of energy from the sun into electrical energy. Some embodiments of the invention provide solar panels that convert solar energy into electrical energy via the photovoltaic process. In some embodiments of the invention, the solar panel generates an electrical voltage and current based on the interaction of solar energy with the materials of the solar panel.

In certain embodiments, the base layer includes a binder and a filler. In certain embodiments, the filler is selected from, by way of non-limiting example, a metal (e.g., a polarizable metal), monocrystalline silica, or combinations thereof. In some embodiments, the filler includes at least one metal particle and monocrystalline silica. In some embodiments, the base layer additional includes an electrical continuity agent. In a specific embodiment, the base layer includes iodine, at least one binder, monocrystalline silica, iron or ferrite, and copper.

In some embodiments, the intermediate layer includes a binder and a filler. In specific embodiments, the filler includes monocrystalline silica. In certain embodiments, the intermediate layer includes both a filler and an electrical continuity agent. In specific embodiments, the filler is monocrystalline silica and the electrical continuity agent is iodine.

In certain embodiments, the top layer includes a binder and a filler. In certain embodiments, the filler is selected from, by way of non-limiting example, a metal, monocrystalline silica or combinations thereof. In some embodiments, the filler includes at least one metal particle and monocrystalline silica. In some embodiments, the top layer further contains an electrical continuity agent. In a specific embodiment, the top layer includes iodine, aluminum, zinc, magnesium, monocrystalline silica, and at least one binder.

In certain embodiments, the base layer includes iodine, at least one binder, monocrystalline silica, iron or ferrite, and copper, the intermediate layer includes at least one binder and monocrystalline silica, and the top layer includes iodine, aluminum, zinc, magnesium, monocrystalline silica and at least one binder. In a specific embodiment, the at least one binder of the top, intermediate, and base layers comprises a vinyl binder (e.g., a copolymer of vinyl chloride and vinyl isobutyl ether, such as MP-15).

Fillers include, by way of non-limiting example, monocrystalline silica and metals (e.g., metal particles, including polarizable metal particles). In more specific embodiments, fillers include, by way of non-limiting embodiment, strontium ferrite powder, magnesium, zinc, beryllium, aluminum, aluminum alloys, cadmium, mild steel, cast iron, low alloy steel, austenitic nickel cast iron, aluminum bronze, naval brass, yellow brass, red brass, tin, copper, Pb—Sn solder, admiralty bras, aluminum brass, manganese bronze, silicone bronze, tin bronzes (G & M), stainless steel (e.g., types 302, 304, 316, 317, 321, 347, 410, 416, 430), nickel silver, copper nickel (including 90-10, 80-20, 70-30), lead, nickel-aluminum bronze, nickel-chromium alloys (e.g., 600), silver braze alloys, nickel 200, silver, nickel-copper alloys (e.g., 400, K-500), alloy 20 stainless steels cast and wrought, nickel-iron chromium alloys (e.g., 825), Ni—Cr—Mo—Cu—Si alloy B, titanium, Ni—Cr—Mo alloy C, platinum, graphite, iron, nickel manganese, chromium, ferrite, bismuth, lithium, boron, mono-silicon, amorphous silicon, phosphorus, scandium, vanadium, molybdenum, graphite, cobalt (e.g., flake and powder), gallium, yttrium, zirconium, or combinations thereof. In some embodiments, the top and base layers contain a different combination of fillers. In some embodiments, the fillers described herein are particles that are dispersed in the layers or paints described herein. In certain embodiments, the top, intermediate and/or base layer fillers are chosen in order to vary the range or spectrum of visible and non-visible light absorbed by the solar panel. In some specific embodiments, the top layer fillers are selected from aluminum, zinc, magnesium, monocrystalline silica, or combinations thereof. In certain specific embodiments, the base layer fillers are selected from copper, monocrystalline silica, iron or ferrite, or combinations thereof.

In some embodiments, the binders of each of the top, intermediate, and base layers are different. In other embodiments, the binders of two of the top, intermediate, and base layers are the same and the other is different. In still other embodiments, the binders of the top, intermediate, and base layers are the same. Binders include binders used in paints. Typical binders include, by way of non-limiting example, epoxy resins, vinyls, acrylic resins, alkyds, polysiloxanes, urethanes, resins, hydrocarbon resins, enamel resins, polyamine resins, polyamide resins, synthetic resins, modified enamel resins, polyurethanes, polyesters, polymer resins, copolymer resins, ethyl silicate, potassium silicate, silicone, siloxane, polyampholyte, an extrudable film base, a water base, or combinations thereof. In specific embodiments, the binder is a vinyl binder, such as a vinyl chloride, vinyl isobutyl ether, a copolymer of vinyl chloride and vinyl isobutyl ether, derivatives thereof, or combinations thereof. In various embodiments, the vinyl binder is selected from polymers, copolymer, or oligomers, by way of non-limiting example, MP-15, MP-25, MP-35, MP-45, or MP-60. In one example, the vinyl binder contains a copolymer of vinyl chloride and vinyl isobutyl ether, such as the commercially available MP-15 copolymer.

In some embodiments, the electrical continuity agent is a doping agent or dopant. In specific embodiments, the electrical continuity agent is iodine. Suitable sources of iodine used herein include, by way of non-limiting example, crystalline iodine and bleached iodine. In certain embodiments, the electrical continuity agent is an agent that facilitates the reduction of dielectric resistance within and/or between the layers of a solar panel described herein.

In some specific embodiments, the present invention provides for a solar panel comprising a base layer, an intermediate layer and a top layer. In some embodiments, the base layer contains a base layer metal and a base layer binder, the intermediate layer contains an intermediate layer metal and an intermediate layer binder and the top layer contains a top layer metal and a top layer binder. In certain embodiments, the base layer metal, base layer binder, intermediate layer metal, intermediate layer binder, top layer metal and top layer binder are all treated with an electrical continuity agent. In certain embodiments, each of the base layer metal, base layer binder, intermediate layer metal, intermediate layer binder, top layer metal and top layer binder are individually treated with an electrical continuity agent (e.g., iodine) prior to being combined in their respective layers.

In some embodiments, the base layer is in direct physical contact with a substrate. In other embodiments, the base layer is in direct physical contact with a primer layer. In certain embodiments, the primer layer is utilized in order to improve uniformity of the surface of the substrate. It is to be understood that as used herein, a base layer deposited on a substrate includes deposition directly onto the substrate or onto a primer layer that has been deposited on a substrate.

In certain embodiments, the present invention provides for solar panels further comprising a protective layer that is applied to the top layer. In some embodiments, the protective layer is transparent to the light sensed by the solar panel, but protects the underlying paint layer structure from weathering and damage, including, e.g., scratching. In some embodiments, the protective layer includes a binder. In certain embodiments, the protective layer is identical in composition to the top layer, with the exception that it does not contain any fillers.

In some embodiments, one or more of the layers described herein is polarized. The layers can be polarized by any method, including those described in the methods of the present invention. In certain embodiments, the layers are polarized by exposing the layer to an electromagnetic field. In more specific embodiments, a layer paint is applied to either a substrate or another layer and the layer is polarized with an electromagnetic field prior to curing and/or drying of the layer.

In some embodiments described herein, panels, arrays, and assemblies are used for collecting various forms of energy and converting the energy collected into electrical energy. In some embodiments, the energy is solar energy and it is converted to electrical energy via the photovoltaic effect. As used herein, the term “solar panel” refers to a panel for collecting any of the various forms of energy suitable for conversion to electrical energy. In some embodiments, the solar panels collect solar energy. In certain embodiments, the solar panels collect visible light, non-visible light, or a combination thereof.

Accordingly, in certain specific embodiments, a solar panel contains a polarized base layer, an intermediate layer and a polarized top layer. In some embodiments, the polarized base layer contains a base layer metal and a base layer binder, the intermediate layer contains an intermediate layer binder and the polarized top layer contains a top layer metal and a top layer binder. In certain embodiments, the polarized base layer is polarized in a first direction and the polarized top layer is polarized in a second direction. In these embodiments, the polarized base layer is deposited on a substrate, the intermediate layer is deposited on the polarized base layer and the polarized top layer is deposited on the intermediate layer. In some embodiments, the first and second directions are the same. In other embodiments, the first and second directions are different. In some embodiments, the intermediate layer is polarized in a third direction. In certain embodiments, the first, second and third directions are the same. In other embodiments, two or more of the first, second and third directions are the same. In yet other embodiments, none of the first, second and third directions are the same. In some embodiments, the base layer contains a second base layer metal and/or a second base layer binder. In certain embodiments, the top layer contains a second top layer metal and/or a second top layer binder. In some embodiments, the intermediate layer contains a second intermediate layer binder. In certain embodiments, the base layer further contains at least one electrical continuity agent. In some embodiments, the top layer further contains at least one electrical continuity agent. In some embodiments, the intermediate layer further contains at least one electrical continuity agent. In specific embodiments, the top and base layers both contain at least one electrical continuity agent. In more specific embodiments, the top, intermediate, and base layers all contain at least one electrical continuity agent. In various embodiments, the electrical continuity agents for each of the layers is the same or different.

Furthermore, in more specific embodiments, the present invention provides for a solar panel comprising a polarized base layer, a polarized intermediate layer and a polarized top layer. In some embodiments, the polarized base layer contains iodine, at least one base layer binder (e.g., a copolymer of vinyl chloride and vinyl isobutyl ether, such as MP-15), monocrystalline silica, iron or ferrite, and copper. In certain embodiments, the intermediate layer contains iodine, at least one intermediate layer binder (e.g., a copolymer of vinyl chloride and vinyl isobutyl ether, such as MP-15) and monocrystalline silica. In some embodiments, the polarized top layer contains iodine, at least one top layer binder (e.g., a copolymer of vinyl chloride and vinyl isobutyl ether, such as MP-15), magnesium, zinc, aluminum, or monocrystalline silica. In these embodiments, the polarized base layer is polarized in a first direction, the polarized top layer is polarized in a second direction and the intermediate layer is polarized in a third direction. Furthermore, the polarized base layer is deposited on a substrate, the intermediate layer is deposited on the polarized base layer and the polarized top layer is deposited on the intermediate layer. In certain embodiments, the at least one base layer binder, the at least one intermediate layer binder and the at least one top layer binder are the same. In specific embodiments, the at least one intermediate layer binder and the at least one top layer binder are a vinyl. In more specific embodiments, the at least one intermediate layer binder and the at least one top layer binder comprise copolymers of vinyl chloride and vinyl isobutyl ether, such as MP-15.

In some embodiments, the present invention provides a solar panel that includes one or more electrically conductive contacts. In certain embodiments, the electrically conductive contact is a strip of electrically conductive material (e.g., a conductive metal) that is in contact with one or more layer of the solar panel.

In one embodiment, the solar panel includes a first and second electrically conductive contact that is in direct physical contact with the base layer and either the substrate, a primer layer, or an insulating layer. In some embodiments, the electrically conductive contacts cover only a fraction of the bottom portion of the base layer. In certain embodiments, the first and second electrically conductive contacts are on opposite ends/sides of the base layer and extend down the length of the end/side. In some embodiments, the electrically conductive contacts extend down the entire length of the end/side. In other embodiments, the electrically conductive contacts extend down a portion of the length of the end/side, stopping short of either corner.

In other embodiments, the solar panel includes a first and second electrically conductive contact that is in direct physical contact with the top layer and the intermediate layer. In some embodiments, the electrically conductive contacts cover only a fraction of the bottom portion of the top layer and/or of the top portion of the intermediate layer. In certain embodiments, the first and second electrically conductive contacts are on opposite sides of the top and intermediate layers and extend down the length of the side/end. In some embodiments, the electrically conductive contacts extend along the entire length of the side/end. In other embodiments, the electrically conductive contacts extend along a portion of the length of the side/end, stopping short of either corner. In certain embodiments, the electrically conductive contacts extend inward from the edge of the side/end of the top and intermediate layers far enough to allow the electrical current produced by the photovoltaic effect of the solar panel to pass through the electrically conductive contact. In some embodiments, the extent to which the electrically conductive contacts extend inward from the edge of the side/end is determined by balancing the minimization of the resistance encountered by the electrical current generated by the photovoltaic effect of the solar panel in reaching the electrically conductive contacts and the allowance of light to reach the intermediate and base layers. In some embodiments, balancing the transparency of the solar panel between the top and intermediate layers with the resistance of the solar panel is used to maximize overall efficiency of the solar panel.

In still other embodiments, the solar panel includes a first and second electrical conductive contact that is in direct physical contact with the base layer and either the substrate, a primer layer, or an insulating layer, and a third and fourth electrical conductive contact that is in direct physical contact with the top layer and the intermediate layer.

In those embodiments wherein the solar panel includes an insulating layer separating the electrically conductive contact from either a primer layer or the substrate, the insulating layer separates the electrically conductive contact from either the substrate or primer layer in order to prevent electrical current from flowing into either the primer layer or the substrate. In various embodiments, the insulating layer covers, by way of non-limiting example, the bottom portion of the conductive contact, the bottom and one or more side portions of the conductive contact, or the entire bottom portion of the solar panel, including the electrically conductive contact and the portion of the base layer that is not in direct contact with the electrically conductive contact (e.g., an insulating primer layer).

In specific embodiments, the present invention provides a solar panel with a base layer, an intermediate layer, a top layer, a first electrically conductive contact, a second electrically conducing contact, a third electrically conductive contact and a fourth electrically conductive contact. In certain embodiments, the base layer contains a base layer metal and a base layer binder, the intermediate layer contains an intermediate layer metal and an intermediate layer binder and the top layer contains a top layer metal and a top layer binder. In some embodiments, the base layer as a bottom portion and a top portion; the intermediate layer has a bottom portion and a top portion; and the top layer has a bottom portion and a top portion. In some embodiments, the first electrically conductive contact is in direct physical contact with the top portion of the intermediate layer and the bottom portion of the top layer; the second electrically conductive contact is in direct physical contact with the top portion of the intermediate layer and the bottom portion of the top layer; the third electrically conductive contact is in direct physical contact with the top portion of the base layer; and the fourth electrically conductive contact is in direct physical contact with the top portion of the base layer. In certain embodiments, when taken together, the first and second electrically conductive contacts cover a fraction of the bottom portion of the top layer. Furthermore, in some embodiments, the first and second electrically conductive contacts cover a fraction of the top portion of the intermediate layer. In some embodiments, the third and fourth electrically conductive contacts cover a fraction of the bottom portion of the base layer. In certain embodiments, the fraction of the bottom portion of the top layer covered by the first and second electrically conductive contacts is small enough that a sufficient amount of light passes through the top and intermediate layers to allow a photovoltaic effect to occur in the base layer. In some embodiments, the first and second electrically conductive contacts cover less than 50% of the bottom portion of the top layer. In specific embodiments, the first and second electrically conductive contacts cover less than about 35%, 25%, 20%, 15%, 10%, 5%, 3%, 2%, or 1% of the bottom portion of the top layer. Similarly, in various embodiments, the first and second electrically conductive contacts cover less than about 50%, 35%, 25%, 20%, 15%, 10%, 5%, 3%, 2%, or 1% of the top portion of the intermediate layer. In some embodiments, the third and fourth electrically conductive contacts cover less than about 50%, 35%, 25%, 20%, 15%, 10%, 5%, 3%, 2%, or 1% of the top portion of the base layer.

The solar panels described herein may be in any shape. In some embodiments, the solar panels are substantially square. In other embodiments, the solar panels are substantially rectangular. In still other embodiments, the solar panels are substantially trapezoidal, oval or circular. In yet other embodiments, the solar panels have a substantially parallelogram-type shape. In some embodiments, the solar panel is shaped in a manner to fit the surface or substrate upon which it is placed. For example, in some embodiments of the invention, the solar panels described herein may be deposited on surfaces of automobiles, buildings, sidewalks, roads, street signs, or other available surfaces.

For convenience, the shapes described herein are described as having ends, sides, corners, but the scope of the invention is not limited to shapes having portions that would conventionally be described as an end, a side or a corner. For convenience, the shapes described herein have been described as possessing two end portions and two side portions. Because the solar panels described herein have a definite shape, the two end portions are simply defined as two portions that are opposite each other. Likewise, the two side portions are simply defined as two portions that are opposite each other and adjacent to the end portions. Similarly, a corner as described herein is simply a junction between an end portion and a side portion. In some embodiments, the junction is continuous and unpronounced (e.g., in embodiments wherein the solar panel is circular in shape), whereas in other embodiments, the junction is pronounced (e.g., in embodiments wherein the solar panel has a square shape).

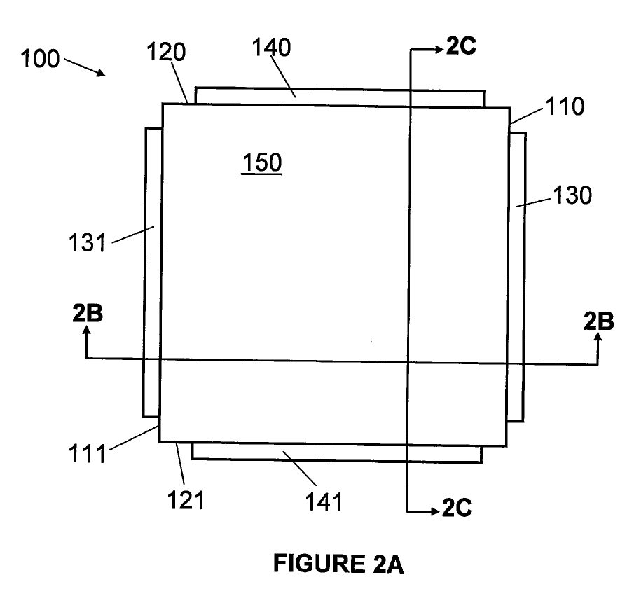

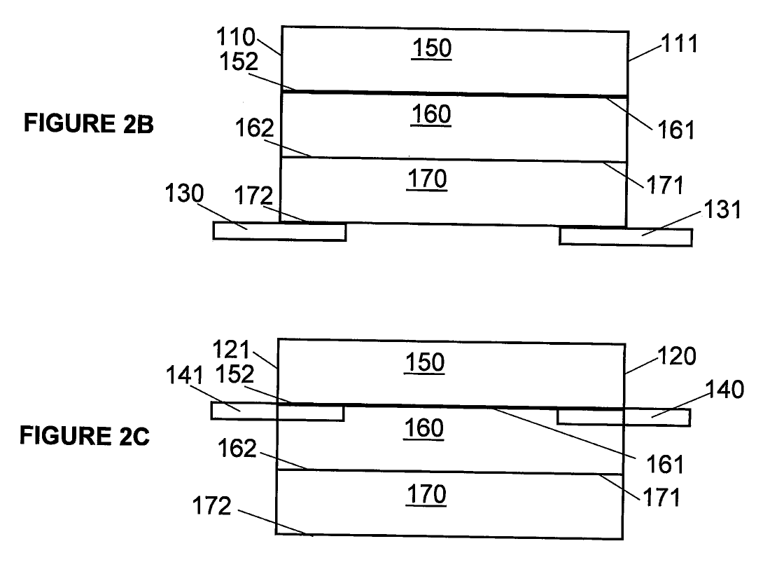

FIGS. 2A-2C illustrate various views of a solar panel 100 as described in some embodiments herein. FIG. 2A illustrates a plan view of a solar panel 100 and FIGS. 2B-2C illustrate a cross sectional view of various layers of a solar panel 100. The solar panel 100 has a substantially square shape with two sides 110, 111 opposite one another. The two sides 110, 111 are adjacent to the two ends 120, 121, which are opposite of each other. Conductive electrical contacts 130, 131 extend along a portion of the length of each side 110, 111. Similarly, conductive electrical contacts 140, 141 extend along a portion of the length of each end 120, 121. As the figure is viewed from the top, the top layer 150 is shown.

FIG. 2B illustrates a sectional view of the solar panel 100 of FIG. 2A along the 2B-2B plane. The bottom portion 152 of the top layer 150 is in direct physical contact with the top portion 161 of the intermediate layer 160. The bottom portion 162 of the intermediate layer 160 is in direct physical contact with the top portion 171 of the base layer 170. The conductive electrical contacts 130, 131 are shown to extend partially inward from the sides 110, 111 and along the bottom portion 172 of the base layer 170. Furthermore, the conductive electrical contacts 130, 131 are shown to extend outward from the sides 110, 111.

FIG. 2C illustrates a sectional view of the solar panel 100 of FIG. 2A along the 2C-2C plane. The bottom portion 152 of the top layer 150 is in direct physical contact with the top portion 161 of the intermediate layer 160. The conductive electrical contacts 140, 141 are shown to extend partially inward from the ends 120, 121 and along the bottom portion 152 of the top layer 150 and along the top portion 161 of the intermediate layer 160. Furthermore, the conductive electrical contacts 140, 141 are shown to extend outward from the ends 120, 121. The bottom portion 162 of the intermediate layer 160 is in direct physical contact with the top portion 171 of the base layer 170.

It is also to be understood that in various embodiments of the invention, the solar panels described herein are deposited on any substrate suitable. Accordingly, in some embodiments, the solar panel is substantially flat, curved or bent. For example, in some embodiments, the solar panel is deposited on the curved roof of an automobile. Suitable substrates include, by way of non-limiting example, steel, concrete, aluminum, wood, cast iron, sheet metal, plastic, tin, fiberglass, or acrylic, such as PLEXIGLAS® acrylic sheets. Furthermore, suitable substrates also include existing coatings, such as paint or primer layers. For example, in some embodiments, the solar panel is deposited on a painted building or automobile.

The layers described herein can be used in any thickness suitable for harnessing electricity from the photovoltaic effect of the solar panel. In certain embodiments, the top layer, intermediate layer and optional protective layers are thin enough that they are at least partially transparent. In some embodiments, the top layer, intermediate layer and optional protective layers are substantially transparent. In certain embodiments, the top, intermediate and optional protective layers are sufficiently transparent to allow light to pass to the base layer and allow a photovoltaic effect to occur therein. In specific embodiments, the top layer has a thickness of between about 45 microns and about 80 microns. In some embodiments, the intermediate layer has a thickness of between about 45 microns and about 80 microns.

In some embodiments, the thickness of the base layer is not limited by a need for transparency. Thus, in certain embodiments, the base layer is any thickness. In some specific embodiments, however, the base layer has a thickness of between about 70 microns and about 150 microns.

It is to be understood that the present invention envisions solar cells with additional photovoltaic layers as well. For example, in addition to a base layer, an intermediate layer and a top layer, certain embodiments of the invention provide for a second intermediate layer in direct physical contact with the top layer and a second top layer that is in direct physical contact with the second intermediate layer. The composition and the thickness of the second intermediate layer and the second top layer are as described herein for the intermediate layer and top layer. The second intermediate layer and the second top layer may have the same or different composition and/or thickness as the intermediate layer and top layer of the solar panel in which they are manufactured. Furthermore, as disclosed for between the top layer and intermediate layer, one or more electrically conductive contacts may be positioned between the second intermediate layer and the second top layer.

In some embodiments, the present invention includes any one or more of the layers described herein. Accordingly, in some embodiments, the present invention encompasses solar panels wherein one or more of the layers described herein are utilized in any position within the solar panel, whether or not it fits within the designation of “base,” “intermediate,” or “top.” Thus, in some embodiments, the present invention provides for a solar panel comprising a layer, wherein the layer contains the components as described herein for a base layer. In some embodiments, the present invention provides for a solar panel comprising a layer, wherein the layer contains the components as described herein for a top layer. In certain embodiments, the present invention provides for a solar panel comprising a layer, wherein the layer contains the components as described herein for an intermediate layer.

In more specific embodiments, the present invention provides for a solar panel comprising a first layer and a second layer, wherein the first layer contains the components as described herein for a base layer and the second layer contains the components as described herein for a top layer. In various embodiments, the first and second layers are deposited in any order (e.g., in some embodiments, the first layer is a base layer and the second layer is a top layer). In some embodiments, the first and second layers are in direct physical contact (e.g., the second layer is deposited directly on top of the first layer).

In even more specific embodiments, the present invention provides for a solar panel comprising a first layer, a second layer and a third layer, wherein the first layer contains the components as described herein for a base layer, the second layer contains the components as described herein for a top layer and the third layer contains the components as described herein for an intermediate layer. In various embodiments, the first, second and third layers are deposited in any order.

### Method of Making

In some embodiments, the present invention provides for methods of making a solar panel and a method of using a solar panel. In general, solar panels are expensive to fabricate and are fragile. Thus, in certain embodiments, the present invention provides for preparing a solar panel described herein by using painting techniques. Suitable painting techniques include, by way of non-limiting example, application by brush, roller, conventional spray equipment, airless spray equipment and electrostatic spray.

In certain embodiments, a base layer is prepared by depositing, using suitable painting techniques, a base layer paint on a substrate (including, e.g., a substrate coated with a primer layer). In some embodiments, the base layer paint is deposited on a substrate and one or more electrically conductive contacts. In some embodiments, the base layer paint is then dried to remove some, substantially all of or all of the paint vehicle and achieve a base layer. In certain embodiments, the base layer paint includes a binder, a filler and a paint vehicle. In certain embodiments, the filler is selected from, by way of non-limiting example, a metal, monocrystalline silica, or combinations thereof. In some embodiments, the filler includes at least one metal particle and monocrystalline silica. In some embodiments, the base layer paint includes an electrical continuity agent. In a specific embodiment, the base layer paint includes iodine, at least one binder, at least one paint vehicle, monocrystalline silica, iron or ferrite, and copper. In a more specific embodiment, the at least one binder comprises a copolymer of vinyl chloride and vinyl isobutyl ether, such as MP-15.

Likewise, in certain embodiments, an intermediate layer is prepared by depositing, using suitable painting techniques, an intermediate layer paint on a base layer. In some embodiments, the intermediate layer paint is then dried to remove some, substantially all of or all of the paint vehicle and achieve an intermediate layer. In some embodiments, the intermediate layer paint includes a binder, a filler and a paint vehicle. In specific embodiments, the filler includes monocrystalline silica. In some embodiments, the intermediate layer paint further contains an electrical continuity agent. In specific embodiments, the filler is monocrystalline silica, the electrical continuity agent is iodine and the binder comprises a copolymer of vinyl chloride and vinyl isobutyl ether, such as MP-15.

In certain embodiments, the top layer is prepared by depositing, using suitable painting techniques, a top layer paint on the intermediate layer. In some embodiments, the top layer is prepared by depositing the top layer paint on an intermediate layer and one or more electrically conductive contacts (e.g., wherein the electrically conductive contacts cover at least a portion of the intermediate layer). In some embodiments, the top layer paint is then dried to remove some, substantially all of or all of the paint vehicle and form the top layer. In certain embodiments, the top layer paint includes a binder, a filler and a paint vehicle. In certain embodiments, the filler is selected from, by way of non-limiting example, a metal, monocrystalline silica, or combinations thereof. In some embodiments, the filler includes at least one metal particle and monocrystalline silica. In some embodiments, the top layer paint further contains an electrical continuity agent. In a specific embodiment, the top layer paint includes iodine, at least one paint vehicle, aluminum, zinc, magnesium, monocrystalline silica and at least one binder. In more specific embodiments, the at least one binder comprises a copolymer of vinyl chloride and vinyl isobutyl ether, such as MP-15.

In certain embodiments, the base layer paint includes at least one paint vehicle, iodine, at least one binder, monocrystalline silica, iron or ferrite, and copper, the intermediate layer includes at least one binder and monocrystalline silica, and the top layer paint includes at least one paint vehicle, iodine, aluminum, zinc, magnesium, monocrystalline silica, and at least one binder. In a specific embodiment, the at least one binder of the top, intermediate, and base layer paints comprises a vinyl binder (e.g., a copolymer of vinyl chloride and vinyl isobutyl ether, such as MP-15).

It is to be understood that the step of drying any of the paints described herein includes partially drying, at least partially drying and completely drying the paint. In other words, the drying step involves removing some, substantially all of or all of the paint vehicle in the paint. In some embodiments, the paints are dried at any temperature suitable. The temperature and length of time necessary to dry the paint depends on the thickness of the paint layer and the nature of the paint vehicle used. In certain embodiments, the drying temperature is between about 0° C. and about 80° C. In specific embodiments, the drying temperature is between about 4° C. and about 45° C. In more specific embodiments, the drying temperature is about 20° C. to about 25° C. In certain embodiments of the invention, the time required for drying the paints will depend on the temperature at which the paint is dried. In some embodiments, the paints are dried for an amount of time sufficient to achieve the level of dryness or to remove the amount of paint vehicle desired (e.g., partial, at least partial, or complete drying). In certain embodiments, the paint is dried for between about 1 minute and about 24 hours. In specific embodiments, the paint is dried for between about 30 minutes and about 8 hours. In specific embodiments, the paint is dried for between about 1 hour and about 6 hours. In more specific embodiments, the paint is dried for about 4 hours.

Accordingly, base layer, intermediate layer and top layer paints include the components (e.g., fillers or binders) described hereinabove for the solar panel layer indicated as well as at least one flowable paint vehicle (e.g., a solvent).

In various embodiments, the flowable paint vehicle of the base layer, intermediate layer and top layer paints are the same or different from one another. In certain embodiments, additives to aid in flow modification and/or impart other properties on the paint composition are included in the paint. In some embodiments, the paint is initially in flowable form. In these embodiments, the paint is applied in the flowable form and thereafter cures and/or dries to a solid form with the filler agents in a solid binder. The solid binder serves as a matrix in which the fillers are embedded and dispersed.

Paint vehicles include, by way of non-limiting example, water, acetone, naphtha, terpene alcohol, alpha-terpineol, methyl ethyl ketone (MEK), xylene, methyl isobutyl ketone (MIBK), glycol ethers, hydrocarbons, halogenated hydrocarbons, oxygenated hydrocarbons, or combinations thereof. Examples of terpene alcohol and acetone mixtures, such as TARKSOL® 97 solvent, TARKSOL® SC Plus solvent, TARKSONE® solvent, available from Tarksol International, L.L.C.

As described herein, in certain embodiments, the paints of the present invention contain a paint vehicle, a binder and a filler. In some embodiments, the paints of the present invention are prepared by treating each individual component with an electrical continuity agent. In certain embodiments, each binder component and each filler component are treated individually with an electrical continuity agent. In some embodiments, each binder component and each filler component are treated individually with an electrical continuity agent in a solvent. In some embodiments, the compositions comprising the solvent and the individually treated components are combined to form the paint. In other embodiments, the solvent is removed, the individually treated components are combined and a paint vehicle is added to form the paint. In still other embodiments, the solvent is removed from at least one of the individually treated components prior to combining the treated components to form the paint. In such embodiments, an additional paint vehicle may or may not be added.

In some embodiments, one or more of the layers described herein is polarized. In various embodiments, the layers are polarized by any method effective therefore. In certain embodiments, the layers are polarized by exposing the layer to an electromagnetic field. In one embodiment, a layer is polarized by connecting one end/side of a layer to the cathode of a battery and connecting the opposite end/side to the anode. In certain embodiments, after a paint is applied to either a substrate or another layer, but prior to complete drying and/or curing of the paint, the layer is polarized with an electromagnetic field. In some embodiments, the base layer, intermediate layer and top layer are all polarized. In certain embodiments, each of the base layer is polarized in a first direct, the intermediate layer is polarized in a second direction and the top layer is polarized in a third direction. In some embodiments, one or more of the first, second and third directions are the same. In other embodiments, none of the first, second and third directions are the same. In some embodiments, the top layer and base layer are polarized, but the intermediate layer is not. In such embodiments, the present invention includes solar panels wherein the top layer and the base layer are polarized in either the same direction or in different directions.

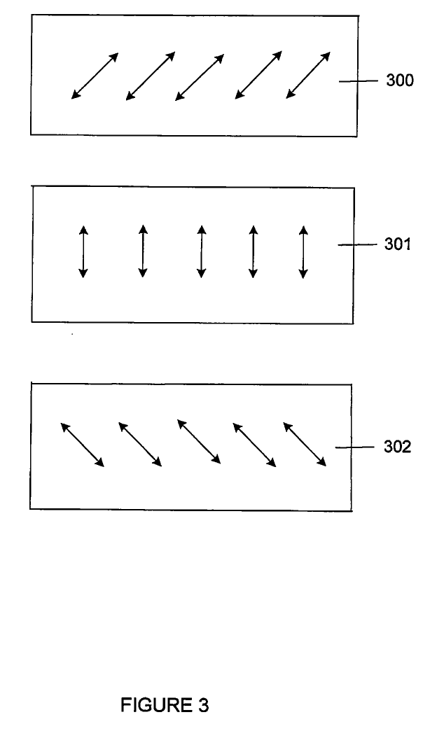

FIG. 3 illustrates various embodiments of the directions 300, 301, 302 that the base, intermediate and/or top layers are polarized. The view provided is at either the top or the bottom portion of the layer.

In specific embodiments, the present invention envisions a method of preparing a solar panel comprising the steps of (i) treating a base layer binder with a first electrical continuity agent to prepare a first composition comprising the first electrical continuity agent and the base layer binder; (ii) treating a base layer metal with a second electrical continuity agent to prepare a second composition comprising the second electrical continuity agent and the base layer metal; (iii) combining the first composition and second composition to prepare a base layer paint comprising the first electrical continuity agent, the second electrical continuity agent, the base layer metal and the base layer binder; (iv) treating a top layer binder with a third electrical continuity agent to prepare a third composition comprising the third electrical continuity agent and the top layer binder; (v) treating a top layer metal with a fourth electrical continuity agent to prepare a fourth composition comprising the fourth electrical continuity agent and the top layer metal; (vi) combining the third composition and the fourth composition to prepare a top layer paint comprising the third electrical continuity agent, fourth electrical continuity agent, the top layer metal and the top layer binder; (vii) depositing the base layer paint on a substrate; (viii) depositing an intermediate layer paint on the base layer paint; and (ix) depositing the top layer paint on the intermediate layer paint, wherein the intermediate layer paint contains an intermediate layer binder and a fifth electrical continuity agent.

In some embodiments, the base layer binder is treated with the first electrical continuity agent in a first solvent and the base layer metal is treated with a second electrical continuity agent in a second solvent. In certain embodiments, the first composition contains the first solvent and the second composition contains the second solvent (and as a result, the base layer paint contains the first and second solvents). In other embodiments, one or both of the first and second solvents are removed and, as a result, the first and/or second compositions do not contain the first or second solvents, respectively. In such embodiments, the base layer paint contains one or none of the first or second solvents. In some embodiments wherein the first and/or second solvents are present in the base layer paint, the solvents present are the base layer paint vehicle. In some embodiments, a paint vehicle is present in the base layer paint, whether or not either of the first or second solvents is present therein.

Similarly, in certain embodiments, the top layer binder is treated with the third electrical continuity agent in a third solvent and the top layer metal is treated with a fourth electrical continuity agent in a fourth solvent. In certain embodiments, the third composition contains the third solvent and the fourth composition contains the fourth solvent (and as a result, the top layer paint contains the third and fourth solvents). In other embodiments, one or both of the third and fourth solvents are removed and, as a result, the third and/or fourth compositions do not contain the third or fourth solvents, respectively. In such embodiments, the top layer paint contains one or none of the third or fourth solvents. In some embodiments wherein the third and/or fourth solvents are present in the top layer paint, the solvents present are the top layer paint vehicle. In some embodiments, a paint vehicle is added to the top layer paint, whether or not either of the third or fourth solvents is present therein.

Likewise, in some embodiments, the intermediate layer binder is treated with the fifth electrical continuity agent in a fifth solvent. In some embodiments, the intermediate layer paint contains the fifth solvent as a paint vehicle or in addition to a paint vehicle. In other embodiments, the fifth solvent is removed prior to preparation of the intermediate layer paint.

In some embodiments, following the step of depositing the base layer paint on a substrate and prior to depositing of the intermediate layer paint on the deposited base layer paint, the deposited base layer paint is dried. Similarly, in some embodiments, following the step of depositing an intermediate layer paint on the deposited base layer paint and prior to the step of depositing the top layer paint on the deposited intermediate layer paint, the deposited intermediate layer paint is dried. As discussed herein, the step of drying includes partially drying, at least partially drying and completely drying the paint.

In certain embodiments, one or more of the layers is polarized. In some embodiments, a layer is polarized by exposing the deposited paint layer to an electromagnetic field. In a specific embodiment, the base layer is polarized after deposition of the base layer paint, but prior to drying of the base layer paint. In some embodiments, the intermediate layer is polarized after deposition of the intermediate layer paint, but prior to drying of the intermediate layer paint. In certain embodiments, the top layer is polarized after deposition of the top layer paint, but prior to drying of the top layer paint. In some embodiments, the top layer is polarized. In specific embodiments, the top and base layers are polarized. In more specific embodiments, the top, intermediate, and base layers are polarized.

Furthermore, as discussed herein, because the base layer need not be transparent, the deposited base layer paint may have a variety of thicknesses. In some embodiments, the deposited base layer paint may have a thickness within a range from about 2 mils DFT (dry film thickness) to about 10 mils DFT. In some embodiments, the deposited base layer paint may have a thickness within a range from about 4 mils DFT to about 6 mils DFT. In specific embodiments, the deposited base layer paint may have a thickness of about 5 mils DFT. In some embodiments, the top and intermediate layers have a thickness that is thin enough to be at least partially transparent. In certain embodiments, deposited the intermediate layer may have a thickness within a range from about 1 mils DFT to about 5 mils DFT. In specific embodiments, the deposited intermediate layer may have a thickness within a range from about 2 mils DFT to bout 3 mils DFT. In some embodiments, the deposited top layer may have a thickness within a range from about 1 mils DFT to about 5 mils DFT. In specific embodiments, the deposited top layer may have a thickness within a range from about 2 mils DFT and bout 3 mils DFT.

In some embodiments, the first, second, third, fourth, and fifth electrical continuity agents are the same. In other embodiments, one or more of the first, second, third, fourth, and fifth electrical continuity agents are the same. In still other embodiments, the first, second, third, fourth, and fifth are different. In certain embodiments, the first, second, third, fourth, and fifth electrical continuity agents are iodine. In some embodiments, the first, second, third, fourth, and fifth solvents are the same. In other embodiments, one or more of the first, second, third, fourth, and fifth solvents are the same. In still another embodiment, none of the first, second, third, fourth, and fifth solvents are the same.

It is to be understood that in addition to the methods described herein, the present invention encompasses solar panels made using the techniques described herein. In some embodiments, the solar panels described herein convert solar energy into electrical energy via the photovoltaic process. In certain embodiments, the solar energy is visible light, non-visible light, or a combination thereof. Furthermore, in some embodiments, the “solar panels” described herein are panels suitable for collecting various forms of energy (solar or otherwise) and converting such energy into electrical energy. The process of converting these various forms of energy to electrical energy may or may not involve the photovoltaic process.

### Modules and Arrays

In some embodiments, the present invention provides for a functional solar panel assemblage including one or more solar panels, one or more solar panel modules, and/or one or more solar panel arrays. In certain embodiments, the present invention provides for a solar panel module comprising a plurality of any of the solar panels described herein. In certain embodiments, the plurality of solar panels connected in a solar panel module described herein is connected to provide a direct current potential. In various embodiments of the invention, the solar panels of the solar panel module are connected in parallel, in series or in a combination thereof. In further embodiments, a plurality of solar panel modules, as described herein, may be connected to provide a solar panel array. In various embodiments, in the solar panel array, the solar panel modules are connected in series, in parallel or in a combination thereof.

In certain embodiments, the solar panel, solar panel module, solar panel array or solar panel assemblage produces direct current. In some embodiments, a solar panel assemblage contains a power inverter that converts direct current to alternating current. In some embodiments, a solar panel module, a solar panel array or a solar panel assemblage contains a direct current combiner that combines direct current of a plurality of solar panels or solar panel modules that are connected in parallel.

In some embodiments, the solar panels present in the solar panel module are connected to one another by an electrically conductive material. In specific embodiments, an electrically conductive contact of a first solar panel is connected by an electrically conductive material to an electrically conductive contact of a second solar panel. In more specific embodiments, an electrically conductive contact of a first solar panel is in direct physical contact with an electrically conductive contact of a second solar panel. In some embodiments, wherein a solar panel contains a first, second, third and fourth electrically conductive contact (e.g., in some embodiments wherein the first and second are between the top and intermediate layers and the third and fourth are in direct physical contact with the bottom portion of the base layer), the first electrically conductive contact is connected to the third electrically conductive contact, the second electrically conductive contact is connected to an electronically conductive contact of a second solar panel, and the fourth electrically conductive contact is connected to an electronically conductive contact of a third solar panel. In other embodiments, wherein a first solar panel contains a first, second, third and fourth electrically conductive contact (e.g., in some embodiments wherein the first and second are between the top and intermediate layers and the third and fourth are in direct physical contact with the bottom portion of the base layer), the first electrically conductive contact is connected to a second solar panel (e.g., to the second electrically conductive contact of the second solar panel), the second electrically conductive contact is connected to an electronically conductive contact of a third solar panel (e.g., to the first electrically conductive contact of the third solar panel), the third electronically conductive contact is connected to a fourth solar panel (e.g., to the fourth electrically conductive contact of the fourth solar panel) and the fourth electrically conductive contact is connected to an electronically conductive contact of a fifth solar panel (e.g., to the third electrically conductive contact of the fifth solar panel). In such embodiments, the top layers of the first, second and third solar panels are connected in series and the base layers of the first, fourth and fifth solar panels are connected in series. All manners of connecting multiple solar panels of the present invention are envisioned herein.

FIG. 4 illustrates an exemplary embodiment of an assemblage comprising a solar panel array. Solar panel array 400 is made up of two solar panel modules 410, 420. The solar panel module 410 is made up of a set of solar panels 411, 412, 413, 414, 415, which are connected in series by electrically conductive material 416. Likewise, solar panel module 420 is made up of a set of solar panels 421, 422, 423, 424, 425, which are connected in series by electrically conductive material 426. Solar panel module 410 and solar panel module 420 are connected in parallel by electrically conductive material 417, 427 at the direct current combiner and disconnect 430. The direct current (DC) produced by the solar panel array proceeds from the direct current combiner and disconnect 430 to the inverter 440 where the current is converted to alternating current (AC). The alternating current proceeds to the alternating current subpanel 450 and on to the alternating current service entrance 460 before proceeding to a utility grid.

It is to be understood that FIG. 4 is for illustrative purposes only. For example, in some embodiments, a solar panel, a solar panel module, a solar panel array, or a solar panel assemblage provides electrical current for a building without first feeding a utility grid. In other embodiments, a solar panel, a solar panel module, a solar panel array, or a solar panel assemblage provides electrical current for an automobile. In still other embodiments, a solar panel, a solar panel module, a solar panel array, or a solar panel assemblage provides electrical current for a satellite. Furthermore, in some embodiments, the direct current produced by the solar panel, solar panel module, solar panel array, or solar panel assemblage is utilized without first converting it to alternating current. In certain embodiments, a solar panel assemblage contains a single solar panel.

In some embodiments, the present invention provides for a solar panel array comprising a plurality of electrically connected solar modules. In some embodiments, at least one or some of the solar panel modules include electrically connected solar panels that are described herein. Accordingly, in certain embodiments, the solar panel modules include a plurality of solar panels formed of multiple layers containing one or more filler and one or more binder within each of the layers. In some embodiments, the fillers are selected from metals (e.g., polarizable metal particles) and monocrystalline silica. In certain embodiments, the combination of fillers utilized in each of the layers is different. In certain embodiments, each layer further contains a common electrical continuity agent for facilitating reduction of dielectric resistance within and between the multiple layers.

As used herein, the disclosure of singular terms such as “a”, “an” and “the” include the disclosure of multiple embodiments of whatever is being described unless otherwise stated. For example, “a binder” includes a disclosure of “one and only one binder”, “at least one binder” and “one or more binder”.

While the foregoing is directed to embodiments of the invention, other and further embodiments of the invention may be devised without departing from the basic scope thereof, and the scope thereof is determined by the claims that follow.

1. A panel of layers for providing electrical energy, comprising:
a base layer comprising a base layer binder, crystalline silica, and at least one base layer metal comprising cobalt;
an intermediate layer comprising an intermediate layer binder and crystalline silica; and
a top layer comprising a top layer binder, crystalline silica, and at least one top layer metal comprising aluminum.

2. The panel of claim 1, wherein each of the base layer binder, the intermediate layer binder, and the top layer binder independently comprises a vinyl material.

3. The panel of claim 2, wherein the vinyl material comprises at least one material selected from the group consisting of vinyl chloride, vinyl isobutyl ether, derivatives thereof, and combinations thereof.

4. The panel of claim 2, wherein the vinyl material comprises a copolymer of vinyl chloride and vinyl isobutyl ether.

5. The panel of claim 1, wherein the base layer binder, the intermediate layer binder, and the top layer binder comprises the same binder material.

6. The panel of claim 1, wherein the base layer has a thickness within a range from about 70 microns to about 150 microns.

7. The panel of claim 1, wherein the top layer has a thickness within a range from about 45 microns to about 80 microns.

8. The panel of claim 1, wherein the intermediate has a thickness within a range from about 45 microns to about 80 microns.

9. The panel of claim 1, wherein each of the base layer, the intermediate layer, and the top layer independently comprises at least one electrical continuity agent.

10. The panel of claim 9, wherein the electrical continuity agent comprises iodine.

11. The panel of claim 1, wherein the base layer further comprises boron.

12. The panel of claim 11, wherein the base layer further comprises iron, nickel, or a combination thereof.

13. The panel of claim 11, wherein the base layer further comprises copper.

14. The panel of claim 11, wherein the base layer further comprises graphite.

15. The panel of claim 1, wherein the top layer further comprises boron.

16. The panel of claim 15, wherein the top layer further comprises cobalt.

17. The panel of claim 15, wherein the top layer further comprises zinc, tin, or a combination thereof.

18. A panel of layers for providing electrical energy, comprising:
a base layer comprising a base layer binder, crystalline silica, and at least one base layer metal;
an intermediate layer comprising an intermediate layer binder and crystalline silica; and
a top layer comprising a top layer binder, crystalline silica, and at least one top layer metal;
a first electrically conductive contact directly coupled to a bottom portion of the top layer; and
a second electrically conducing contact directly coupled to a top portion of the base layer.

19. A panel of layers for providing electrical energy, comprising:
a base layer comprising iodine, at least one base layer binder, crystalline silica, iron, and copper;
an intermediate layer comprising iodine, at least one intermediate layer binder, and crystalline silica;
a top layer comprising iodine, at least one top layer binder, magnesium, zinc, aluminum, and crystalline silica; and
a substrate, wherein the base layer is disposed on the substrate, the intermediate layer is disposed on the base layer, and the top layer is disposed on the intermediate layer.

20. A panel array comprising a plurality of panels connected to provide a current potential, wherein each of the panels further comprises:
a base layer comprising iodine, at least one base layer binder, crystalline silica, iron, and copper;
an intermediate layer comprising iodine, at least one intermediate layer binder, and crystalline silica;
a top layer comprising iodine, at least one top layer binder, magnesium, zinc, aluminum, and crystalline silica; and
a substrate, wherein the base layer is disposed on the substrate, the intermediate layer is disposed on the base layer, and the top layer is disposed on the intermediate layer.

21. A method for forming a panel of layers for providing electrical energy, comprising:
treating a base layer binder with a first electrical continuity agent to prepare a first composition comprising the first electrical continuity agent and the base layer binder;
treating a base layer metal with a second electrical continuity agent to prepare a second composition comprising the second electrical continuity agent and the base layer metal;
combining the first composition and second composition to prepare a base layer composition comprising the first electrical continuity agent, the second electrical continuity agent, the base layer metal, and the base layer binder;
treating a top layer binder with a third electrical continuity agent to prepare a third composition comprising the third electrical continuity agent and the top layer binder;
treating a top layer metal with a fourth electrical continuity agent to prepare a fourth composition comprising the fourth electrical continuity agent and the top layer metal;
combining the third composition and the fourth composition to prepare a top layer composition comprising the third electrical continuity agent, fourth electrical continuity agent, the top layer metal, and the top layer binder;
depositing a base layer from the base layer composition on a substrate;
depositing an intermediate layer on the base layer, wherein the intermediate layer comprises an intermediate layer binder and a fifth electrical continuity agent; and
depositing a top layer from the top layer composition on the intermediate layer.

22. The method of claim 21, wherein each of the first electrical continuity agent, second electrical continuity agent, third electrical continuity agent, fourth electrical continuity agent, and fifth electrical continuity agent independently comprises iodine.

23. The method of claim 21, wherein each of the base layer binder, the intermediate layer binder, and the top layer binder independently comprises a vinyl material.

24. The method of claim 23, wherein the vinyl material comprises at least one material selected from the group consisting of vinyl chloride, vinyl isobutyl ether, derivatives thereof, and combinations thereof.

25. The method of claim 23, wherein the vinyl material comprises a copolymer of vinyl chloride and vinyl isobutyl ether.
